(19) United States
(12) Patent Application Publication
(10) Pub. No.: US 2013/0070071 A1
(43) Pub. Date: Mar. 21, 2013

(54) Single-Use Bispectral Optical Head for Videoendoscope and Associated Videoendoscope

(71) Applicants: Philippe PELTIE, Saint Paul de Varces (FR); Jérôme BOUTET, Claix (FR); Philippe RIZO, La Tronche (FR)

(72) Inventors: Philippe PELTIE, Saint Paul de Varces (FR); Jérôme BOUTET, Claix (FR); Philippe RIZO, La Tronche (FR)

(73) Assignee: Commissariat a I'Energie Atomique et aux Energies Alternatives, Paris (FR)

(21) Appl. No.: 13/420,467

(22) Filed: Mar. 14, 2012

(30) Foreign Application Priority Data
Mar. 15, 2011 (FR) 11 52100

(51) Int. Cl. H04N 7/18

(52) U.S. Cl. CPC H04N 7/18
USPC 348/68

(57) ABSTRACT

In the field of videoendoscopes for medical or industrial use, a videoendoscope has a bispectral optical head comprising a microcamera, white light lighting means and fluorescence light lighting means. The optical head is linked by appropriate electrical and optical connectors to the other elements of the videoendoscope. Preferably, it comprises inexpensive standard elements and is packaged in a single-use sterile packaging. There are different possible embodiments depending on whether the optical head comprises a single sensor or two sensors, depending on whether the device operates in continuous mode or in sequential mode and, finally, depending on whether the light sources are incorporated in the optical head or external thereto, the light being then routed by means of optical fibres.

### CROSS-REFERENCE TO RELATED APPLICATION

This application claims priority to foreign French patent application No. FR 1152100, filed on Mar. 15, 2011, the disclosure of which is incorporated by reference in its entirety.

### FIELD OF THE INVENTION

The technical field of the invention is that of endoscopy, more specifically that of “videoendoscopes”. The preferred application of these instruments is the medical field, but endoscopy also has applications in the industrial environment. Thus, in the motor vehicle or aeronautical fields, such probes are used to inspect areas that are not easily accessible such as certain parts of engines.

### BACKGROUND

Currently, the systems most widely used in endoscopy are rigid endoscopes, or flexible endoscopes or fibroscopes.

The rigid endoscopes have a diameter of between 5 and 8 millimetres and a length of between 15 and 30 centimetres. They consist of an optical image-taking and image transport assembly. They have a good resolution but their use is necessarily limited to particular organs, such as the bladder, or exploration of the joints. These endoscopes which comprise a sophisticated optical system have a fairly high price.

The flexible endoscopes comprise an image conductor consisting of a bundle of ordered optical fibres. They have a diameter of a few millimetres and a length which can exceed a metre allowing access to organs such as the bronchi, the intestines or the stomach. These fibroscopes have a mediocre resolution that is necessarily limited by the number of optical fibres of the image conductor. This number does not exceed 80 000 in order to retain a small diameter and a certain flexibility. They also have a fairly poor transmission in the low wavelengths such as blue. Furthermore, they are fragile and, like the rigid endoscopes, their cost is high.

Newly emerging over the last ten or so years, videoendoscopes constitute a new generation of endoscopes allowing for the in vivo exploration of fairly inaccessible organs. The specific feature of the videoendoscopes is that the camera which films the organ being examined is arranged at the end of the flexible conduit. There is therefore no longer any need to optically convey the image to the other end of the endoscope. This new generation has become possible by virtue of the very small size of the current photodetectors, usually of “CCD” type. Thus, the so-called ¼″ format is very widely used, but so-called 1/10″ formats, meaning that the diagonal of the photodetector does not exceed a few millimetres, can now easily be found. Furthermore, these sensors have high resolutions. The best resolutions are of the order of 850 000 pixels for ¼″ or ⅙″ formats, or ten times greater than those of the conventional fibroscopes. Furthermore, the transmission of the signals is much superior, the chromatic aberrations being corrected. Images of much better quality are thus obtained. On this subject, the article entitled “Nouveautés diagnostiques en endoscopie [diagnostic novelties in endoscopy], T. Ponchon, Gastroenteral Clin. Biol. 2001” can be read with interest.

Since the endoscope is used inside the human body, one of the major problems is the need to sterilize the equipment before each intervention unless it is disposable. Now, it is not possible to correctly sterilize a videoendoscope since the CCD matrix has to be raised to high temperatures, of the order of 120 degrees, and in a wet environment.

A second problem is that these endoscopes do not comprise any fluorescence pathway for examining the sick organ. The addition of a fluorescence pathway is not necessarily simple inasmuch as the bulk is strictly limited. It is, for example, out of the question to add a second detection matrix dedicated to the fluorescence light.

### SUMMARY OF THE INVENTION

The videoendoscope according to the invention resolves these two problems. It does this by combining, in a single optical head, all the means for producing both an image in “white” light and in fluorescence imaging on one and the same CCD sensor. Also, the simplicity of the optical head and the inexpensive price of the elements of which it is composed mean that the optical head may be for single use and disposed of after use, thus avoiding any sterilization problem. Even in the industrial applications that do not require sterilization, it is obvious that the inexpensive cost of the optical head is a significant draw inasmuch as it is no longer necessary to take care of the endoscope or to carry out tedious cleaning operations.

More specifically, a first subject of the invention is a bispectral optical head for videoendoscope comprising at least one photosensitive sensor, a lens associated with said photosensitive sensor and white light lighting means, characterized in that the optical head also comprises at least: a lighting means suitable for emitting a monochromatic light at a predetermined wavelength, optical filtering means for filtering said predetermined wavelength in a narrow spectral band, said filtering means arranged so as to filter the image formed by the lens on the photosensitive sensor, and electrical or optical connectors linked to the white light lighting means, to said lighting means and to the photosensitive sensor and intended to be coupled respectively to power supply means and to image analysis means of the videoendoscope.

Advantageously, the lighting means comprise fibreoptic links intended to be coupled to lighting sources positioned outside the optical head, the light from said lighting sources being routed to the optical head by said fibreoptic links or, in a variant, the lighting means comprise lighting sources positioned in the optical head.

Advantageously, the white light lighting sources are at least one white light-emitting diode, the photosensitive sensor being a “colour” sensor, that is to say, comprising a so-called “RGB” filter positioned in front of the pixels of the sensor.

Alternatively, the white light lighting sources are at least a triplet of light-emitting diodes emitting in three different spectral bands, the photosensitive sensor being monochrome.

Finally, the white light lighting means comprise at least one organic light-emitting diode or OLED.

Advantageously, the lighting means suitable for emitting a monochromatic light comprises at least one organic light-emitting diode or OLED and the predetermined wavelength of the lighting means suitable for emitting a monochromatic light is approximately 690 nanometres.

Advantageously, the optical head comprises two photosensitive sensors, optically coupled to a second spectral filtering means, the second filtering means ensuring the spectral separation between, on the one hand, a fluorescence light spectrum from a determined object lit by the monochromatic light and, on the other hand, the rest of the spectrum of the white light. Advantageously, the second filtering means comprises a dichroic filter.

In a preferred embodiment, the photosensitive sensors are positioned orthogonally to one another and symmetrically on either side of the dichroic filter.

In another preferred embodiment, the optical head comprises optical means arranged so that the photosensitive sensors are positioned parallel to one another. The optical head comprises optical means arranged so that the photosensitive sensors are positioned in the same plane and integrated on a common substrate.

Advantageously, the photosensitive sensor(s) is/are of CMOS type, in 1/10″ format.

Advantageously, before use, the optical head is packaged in a single-use disposable sterile packaging.

A second subject of the invention is a videoendoscope comprising an optical head, a power supply for the lighting means of said optical head, means for analysing and displaying an image supplied by at least one photosensitive sensor positioned in said optical head, characterized in that: the optical head is as defined previously; in operational use, the white light and monochromatic light lighting means, and the photosensitive sensor(s) is/are linked respectively to the power supply and to the image analysis means of the videoendoscope by connectors, and the videoendoscope comprises means allowing for the sequential addressing of either the white light lighting means or the lighting means suitable for emitting a monochromatic light at a predetermined wavelength.

Advantageously, when the white light lighting means are at least one triplet of light-emitting diodes emitting in three different spectral bands, the videoendoscope comprises means for sequentially addressing each diode of said triplet of light-emitting diodes.

### BRIEF DESCRIPTION OF THE DRAWINGS

The invention will be better understood and other advantages will become apparent from reading the following description, given as a nonlimiting example, and from the appended figures in which:

FIG. 1 represents a general view of an optical head according to the invention and of the entire associated videoendoscope in a first embodiment;

FIG. 2 represents the variation of transmission as a function of the wavelength of the optical filtering means;

FIG. 3 represents a second embodiment of the optical head in a version comprising two sensors;

FIG. 4 represents a first variant of this second embodiment of the optical head;

FIG. 5 represents a second variant of this second embodiment of the optical head;

FIG. 6 represents a third variant of this second embodiment of the optical head.

### DETAILED DESCRIPTION

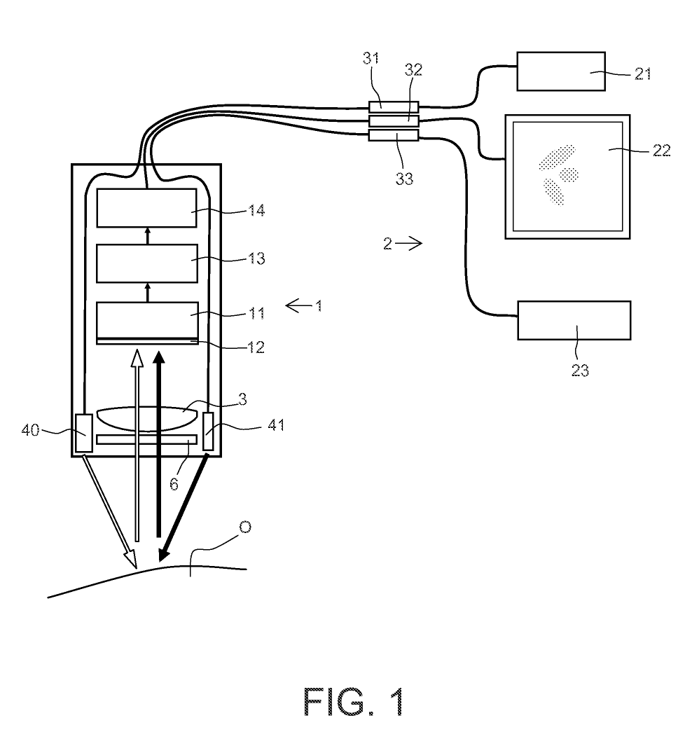

As as a first nonlimiting example, FIG. 1 represents a general view of a first embodiment of a videoendoscope according to the invention. It essentially comprises an optical head 1 and an assembly 2 for providing the power supply and analysing the images obtained from the optical head 1.

The optical head 1 comprises a microcamera composed of the photosensitive sensor 11 and the lens 3. The microcamera forms an image of the object O on the sensor 11. One of the important requirements of the optical head, given its possible use in a medical environment, is that it should have the smallest possible diameter. The photosensitive sensor is therefore preferably a sensor of “CMOS” type in the 1/10″ format comprising around a million pixels. The dimensions of the sensor do not exceed a few millimetres, the image field is a square with 2 millimetre sides and the size of the individual pixels does not exceed 2 microns. The lens is a microoptic with a focal length of 2 millimetres. If this lens has an enlargement of 5, it allows for a high resolution image of an object with dimensions of approximately 10×10 millimetres to be taken. The working distance, that is to say the distance separating the last dioptre of the lens from the object to be observed, is of the order of 12 mm. The numerical aperture NA is then 0.42. This type of sensor and of optic are commonly used for applications in mobile telephony.

The photosensitive sensor is linked to image forming means, for example an amplifier 13 and an analogue-digital converter 14. The output of the converter 14 is connected to a conventional image analysis system 22 by means of the connection system 32.

The optical head has two imaging pathways.

The first pathway can be used to produce colour images of the object to be observed. It comprises white light lighting means 40. The light radiation is represented by a white arrow in FIG. 1 and in the other figures. These means are preferably one or more micro-light-emitting diodes. These diodes are powered by a power supply 21 through the connection system 31. The white light may be provided either by so-called “white” diodes emitting directly in a spectrum spanning the entire visible spectrum, or by triplets of diodes emitting respectively in the red, green and blue spectral bands of the visible spectrum. In the first case, the sensor is necessarily a “colour” sensor. It comprises a so-called “RGB” mosaic filter 12 to produce a colour image. In the second case, it is possible to use a monochrome sensor without RGB filter provided that the red, green and blue diodes are addressed sequentially. Three red, green and blue images are thus recorded sequentially to enable the original colour image to be reconstructed. In this case, the resolution is better but the acquisition rate is less fast. This white light lighting means 40 may comprise one or more organic light-emitting diodes.

The second pathway can be used to produce fluorescence images of the observed object O. It comprises a lighting means 41, suitable for emitting a monochromatic light represented by a black arrow in FIG. 1 and in the other figures. This lighting means 41 may be an optical fibre suitable for transmitting the monochromatic light obtained from a fibred laser emission source 23. Preferably, this source emits at a wavelength of 690 nm, a wavelength that is favourable to the fluorescence of living tissues.

The optical fibre is a standard fibre of “Telecom” type. It is connected by means of an optical connection system 33 to the source 23. The fluorescence image obtained is picked up by the microcamera 11.

To obtain a correct fluorescence image, the lighting needed for the lit object has to be of the order of 25 μW/mm². For an object field of the order of 100 mm², this gives an excitation power of 2 to 3 mW. There is no difficulty in conveying such a power in optical fibres, a power which remains well below the laser safety standards.

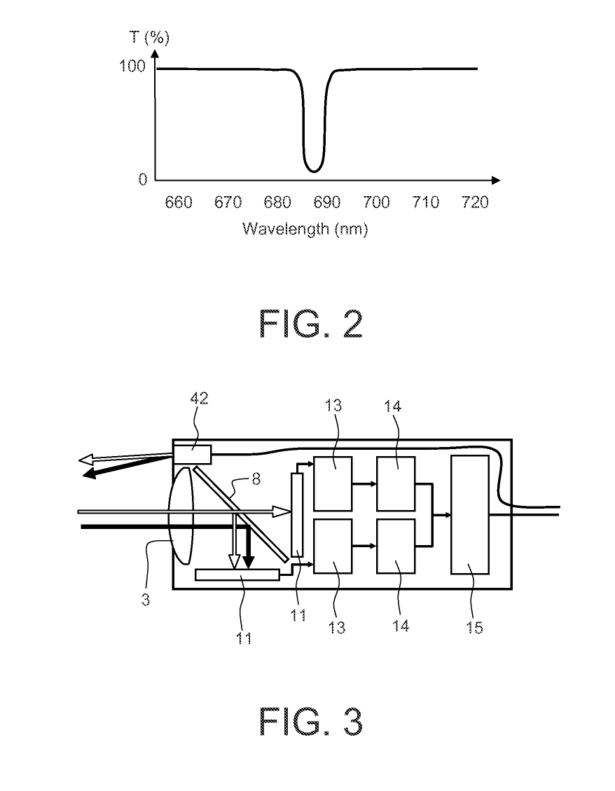

This image must not be polluted by the stray light due to the backscattering of the tissues lit by the excitation light. To be free of such backscattering, a so-called “notch” filter 6, in other words an interferential filter which cuts exclusively the spectral component at 690 nm with a very narrow width of the order of a few nanometres, is positioned on the microcamera. As an indication, the transmission of this filter as a function of the wavelength is represented in FIG. 2. This filter permanently placed in front of the optic does not significantly degrade the colour image since it removes from the visible spectrum only a narrow band of light around 690 nm, that is to say that the sensor will fully restore the blue, green and almost all the red of the image.

The alternation between the colour image and the fluorescence image is obtained simply by sequentially switching on the white lighting diodes and then the laser. The image system ensures the selection of the image to be displayed. Thus, the microcamera is bispectral and allows for the acquisition both of a colour image and of a fluorescence image. Obviously, these images can be presented separately, be superposed and benefit from image processing operations.

FIG. 3 shows a second embodiment of the optical head 1 based on the use of two matrix image sensors 11. The two photosensitive sensors are positioned orthogonally to one another and symmetrically on either side of a dichroic filter 8.

One of the two photosensitive sensors 11 operates in monochrome mode, also called “black and white”. It allows for the acquisition of the fluorescence image. The second photosensitive sensor is a colour sensor. These photosensitive sensors are linked to image forming means, for example amplifiers 13 and analogue-digital converters 14, these assemblies forming either a black and white camera or a colour camera. Such photosensitive sensors may be sensors produced in CCD or CMOS technology. The black and white camera and the colour camera can be linked to a multiplexer 15, for the transmission of the digital signal to the image reception unit remote from the endoscope.

According to a first variant, the device has two distinct operating modes, which can be executed sequentially to acquire the fluorescence image and the colour image. During the acquisition of the fluorescence image, the excitation light arrives via the lighting optical fibre 42, the spectrum of this light corresponds to the absorption spectrum of the fluorophore of the tissue and more generally of the object that is to be observed. The fluorescence light is then picked up by the lens 3 and is reflected by the dichroic filter 8. In the example of FIG. 3, the dichroic filter 8 is reflecting for this wavelength range. So, it is possible to place a notch filter permanently in front of the optic 3.

During the acquisition of the visible image, the light sent into the lighting optical fibre 42 is a white light. This is reflected on the tissues and is spectrally divided by the dichroic filter 8. The colour image is obtained by the summation of the images collected on the two photosensitive sensors 11.

According to a second variant, these two modes coexist simultaneously by sending into the optical fibre a light whose spectrum contains all the spectrum between the blue and the wavelength at which the fluorescence spectrum is to be separated from the excitation spectrum. In this case, the fluorescence image is obtained on just one of the two photosensitive sensors 11, and the colour image, by summation of the images obtained by the two photosensitive sensors 11.

Obviously, it is possible to use a dichroic filter that transmits the fluorescence light instead of reflecting it.

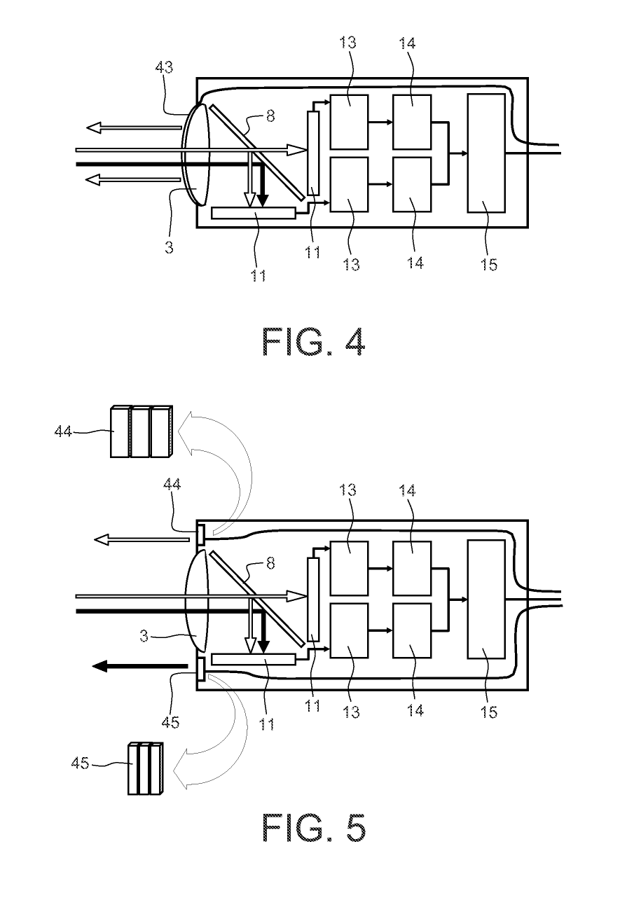

As has been seen in the preceding exemplary embodiments, the light obtained from the optical head may originate from optical fibres connected to light sources external to the optical head. Powerful and spectrally well defined light sources are thus available. It is also possible, to avoid the use of optical fibres, to have light sources inside the optical head itself. FIG. 4 thus represents a first variant embodiment of the optical head as represented in FIG. 3. In this variant, a light source 43 is positioned at the optical head end. The detection and filtering means are similar to those of the preceding embodiment. This light source is produced by depositing an organic polymer on the surface of the lens. This polymer is of OLED (organic light emitting diode) type. This polymer is chosen to emit the spectrum situated below the fluorescence wavelength in order to avoid disturbing the fluorescence image acquisition. Another possibility is to deposit two polymers, one emitting the spectrum between the start of the visible spectrum and the excitation wavelength inclusive, the second polymer emitting the spectrum between the excitation wavelength and the red part of the visible spectrum.

By simultaneously switching on the two OLEDs, a non-distorted white lighting source is reconstructed. According to this embodiment, each polymer forming an OLED is linked to a voltage source, not represented in FIG. 4, which is integrated in the optical head of the endoscope, or placed remotely and linked by an electrical connection means. This voltage source may be common to the one supplying the image sensors 11 or the image forming means 13, 14 and 15.

FIG. 5 represents a second variant embodiment of the optical head as represented in FIG. 3. it comprises detection characteristics similar to those of the embodiment explained in FIG. 3 and in FIG. 4. According to this embodiment, the light source is embedded in the endoscope end in the form of a strip 44 of three-colour light-emitting diodes or LEDs, intended to reconstruct a white light source. This strip may be replaced by white diodes. However, the use of three separate LEDs is preferable inasmuch as it becomes possible to adjust the colour temperature as a function of the type of pathology that is to be observed. In this embodiment, the light source 45 allowing for excitation of the fluorescence is a strip of one or more laser diodes at the absorption wavelength of the fluorophore being studied.

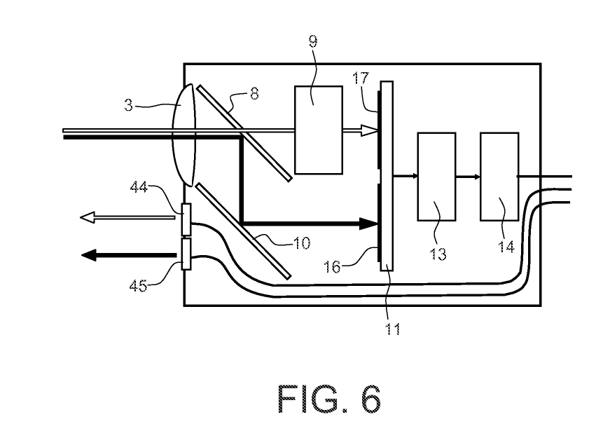

FIG. 6 describes an embodiment in which a single camera is used to produce both colour and fluorescence images. The term “camera” should be understood here to mean a matrix photosensitive sensor, linked to image forming means, these means being, for example an amplifier 13 and an analogue-digital converter 14. According to this embodiment, the matrix photosensitive sensor is divided into two photosensitive sensors 16 and 17, each occupying a part of the matrix, each intended to acquire a different image. The advantage is a lower cost and a greater miniaturization. The light source is identical to the one described in the embodiment of FIG. 5, but the LEDs and the laser diodes are grouped together under the lens of the endoscope in order to exploit the space left free by the dissymmetry of the assembly. The fluorescence light reflected on the object being studied is collected by the objective 3, then reflected by a dichroic filter 8. It is then reflected on a flat mirror 10 then projected onto the bottom half 16 of the image sensor 11. The white light from the object is collected by the lens 3 and transmitted by the dichroic filter 8 and filtered by a fluorescence filter. It then reaches the top portion 17 of the image sensor 11 which digitizes it. To balance the two optical paths and avoid having one of the two images defocused relative to the other, a glass plate 9 is placed in the shortest optical path so that the two optical paths are the same for the fluorescence image and the white image. It is possible to achromatize this plate by producing it in two types of glass with different optical indices and constringence. It will be recalled that the optical path denoted ∂ is such that:

∂=n×d, with:

n: optical index crossed

d: distance travelled for the fluorescence image and the white image.

The use of microcameras whose components are derived from mobile telephony, of micro-light-emitting diodes and of standard optical fibres coming from telecommunications makes it possible to achieve very low optical head production costs. Thus, the optical head may be for one-time use and disposed of after use. In this case, it is packaged in a single-use sterile packaging. Any risk of contamination is thus avoided and the use of the videoendoscope is considerably simplified by eliminating the complex post-use sterilization operations.

1. A bispectral optical head for a videoendoscope comprising at least one photosensitive sensor, a lens associated with said photosensitive sensor and white light lighting means, the optical head comprising:
a lighting means suitable for emitting a monochromatic light at a predetermined wavelength,
optical filtering means for filtering said predetermined wavelength in a narrow spectral band, said filtering means arranged so as to filter the image formed by the lens on the photosensitive sensor, and
electrical or optical connectors linked to the white light lighting means, to said lighting means and to the photosensitive sensor and intended to be coupled respectively to power supply means and to image analysis means of the videoendoscope.

2. A bispectral optical head for videoendoscope according to claim 1,
wherein the lighting means comprise fibreoptic links intended to be coupled to lighting sources positioned outside the optical head, the light from said lighting sources being routed to the optical head by said fibreoptic links.

3. A bispectral optical head for videoendoscope according to claim 1,
wherein the lighting means comprise lighting sources positioned in the optical head.

4. A bispectral optical head for videoendoscope according to claim 1,
wherein the white light lighting sources are at least one white light-emitting diode, the photosensitive sensor being a “colour” sensor comprising a “RGB” filter positioned in front of the pixels of the sensor.

5. A bispectral optical head for videoendoscope according to claim 1,
wherein the white light lighting sources are at least a triplet of light-emitting diodes emitting in three different spectral bands, the photosensitive sensor being monochrome.

6. A bispectral optical head for videoendoscope according to claim 1,
wherein the white light lighting sources comprise at least one organic light-emitting diode or OLED.

7. A bispectral optical head for videoendoscope according to claim 1,
wherein the lighting source suitable for emitting a monochromatic light comprises at least one organic light-emitting diode or OLED.

8. A bispectral optical head for videoendoscope according to claim 1,
wherein the predetermined wavelength of the lighting means suitable for emitting a monochromatic light is approximately 690 nanometres.

9. A bispectral optical head for videoendoscope according to claim 1,
further comprising two photosensitive sensors, optically coupled to a second spectral filtering means, the filtering means ensuring the spectral separation between, on the one hand, a fluorescence light spectrum from a determined object lit by the monochromatic light, and, on the other hand, the rest of the spectrum of the white light.

10. A bispectral optical head for videoendoscope according to claim 9,
wherein the second filtering means comprises a dichroic filter.

11. A bispectral optical head for videoendoscope according to claim 10,
wherein the photosensitive sensors are positioned orthogonally to one another and symmetrically on either side of the dichroic filter.

12. A bispectral optical head for videoendoscope according to claim 9,
wherein the optical head comprises optical means arranged so that the photosensitive sensors are positioned parallel to one another.

13. A bispectral optical head for videoendoscope according to claim 12,
wherein the optical head comprises optical means arranged so that the photosensitive sensors are positioned in the same plane and integrated on a common substrate.

14. A bispectral optical head for videoendoscope according to claim 1,
wherein the at least one photosensitive sensor is of CMOS type, in 1/10″ format.

15. A bispectral optical head for videoendoscope according to claim 1,
wherein, before use, the optical head is packaged in a single-use disposable sterile packaging.

16. A videoendoscope comprising an optical head, a power supply for the lighting means of said optical head, means for analysing and displaying an image supplied by at least one photosensitive sensor positioned in said optical head, wherein the optical head is in accordance with claim 1, and
wherein, in operational use, the white light and monochromatic light lighting means and the at least one photosensitive sensor are linked respectively to the power supply and to the image analysis means of the videoendoscope by connectors; and
the videoendoscope further comprises means allowing for the sequential addressing of either the white light lighting means, or the lighting means suitable for emitting a monochromatic light at a predetermined wavelength.

17. A videoendoscope according to claim 16, wherein, when the white light lighting means are at least one triplet of light-emitting diodes emitting in three different spectral bands, and said videoendoscope comprises means for sequentially addressing each diode of said triplet of light-emitting diodes.
